(19) United States
(12) Patent Application Publication
(10) Pub. No.: US 2026/0057747 A1
(43) Pub. Date: Feb. 26, 2026

(54) CASINO SYSTEM AND METHOD FOR CONDUCTING CARD GAME

(71) Applicant: Mercy Commerford, Las Vegas, NV (US)

(72) Inventor: Mercy Commerford, Las Vegas, NV (US)

(21) Appl. No.: 18/809,666

(22) Filed: Aug. 20, 2024

(51) Int. Cl. G07F 17/32

(52) U.S. Cl. CPC G07F 17/3293

(57) ABSTRACT

This present disclosure relates generally to an improved wagering system and method of use thereof. More specifically, this invention relates to a unique and novel implementation permitting wagers on the unknown attributes of a hidden card. Other improvements in the design and implementation of the gaming system are also included in this disclosure

### FIELD OF THE INVENTION

The present invention relates to the field of gaming, particularly to the field of wagering games involving random gaming implements, such as cards, and more particularly to modified and unique wagering games.

### BACKGROUND

As gaming continues to enjoy widespread acceptance, casinos are increasingly in need of new games of chance to retain and attract patrons. The potential pool of patrons has been limited because many casino games have complicated rulesets that are either confusing or intimidating to inexperienced players. Increasing the accessibility of gaming to inexperienced players will ultimately increase the discreet number of patrons. It is an object of the present disclosure to provide a system and method of an easily understood and welcoming experience for new players.

Card games, using either physical or virtual playing cards, remain a fundamental source of entertainment. In many variations, however, table games do not provide as much volatility or opportunities to affect the game as some players would prefer. Nor do most variations provide opportunities for players to increase their chances of winning the game or the amount gained. Thus, there remains a need for an improved system of facilitating table games that increases the volatility and/or number of opportunities for players to affect the game, thereby increasing the enjoyment of the games for many players and attracting additional players to the games. It is an object of the present disclosure to enable an increased variation, volatility, and opportunity to change the outcome of a game applicable to any wagering game.

Casinos have limited opportunities to increase their revenue. Simply, their revenue is a function of the number of players, the number of games played, the amount of payout, and the price of each hand. The number of games played in a discrete amount of time directly influences the profitability of games. The more games and hands played, the more revenue is collected for the gaming institution. Thus, it is highly desired to create an entertaining game that can be readily accessed and played quickly. Other methods of increasing revenue have large drawbacks. The price of each game may be raised; however, increasing the price creates a deleterious effect on the number of patrons willing to play a game. Similarly, the payout may be lowered; however, players will avoid games with low payouts.

It can be seen, therefore, there is a system and method needed to enable an efficient and reliable method of attaching and detaching a suction means for a holding apparatus.

### SUMMARY

This present disclosure has overcome the disadvantages and shortcomings of the prior art by implementing a new, novel, and modular design for a casino gaming system and method enabling greater ease of access to inexperienced players and high rate of play for a plurality of players.

The method of playing a wagering game comprising steps of placing a wager on a plurality of card attributes of an unknown card, displaying one card face up, taking all losing wagers, and paying all winning wagers pursuant to odds displayed in the betting area.

Optionally or alternatively, this method may be attached to any current wagering game as an additional side game enhancement following the same method as above. For example, in a standard game of blackjack wherein the player and dealer take two cards of a standard plurality of playing card decks, one face up and the other face down, and the player is attempting to get closer to twenty-one without going over than the dealer. The enhanced method applied to blackjack may include a payout enhancement predicated on a successful wager on one or more aspects of the next card to be played such as the number, suit, or other features of the card. Optionally or alternatively, an independent deck of non-standard or unique cards may be used as an optional side bet in the aforementioned system and method.

The simplicity and modular design of this system and method provides innumerable opportunities to enhance the profitability of casino gaming and the entertainment of players.

With respect to the above description, the present invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

This summary is not intended to identify key features or essential features of the claimed subject matter, nor is it intended to be used as an aid in determining the scope of the claimed subject matter.

Additional features and advantages of exemplary implementations of the present disclosure will be set forth below, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

These and other features, aspects, and advantages of the invention will be further understood and appreciated by those skilled in the art by reference to the following written specification, claims and disclosure drawings.

### BRIEF DESCRIPTION OF DRAWINGS

An embodiment of the present invention will hereinafter be described in conjunction with appended drawings, provided to illustrate and not to limit the invention.

FIG. 001 illustrates a perspective view of gaming table in accordance with one embodiment of the present invention;

FIG. 002 illustrates a perspective view of a betting area in accordance with one embodiment;

### DETAILED DESCRIPTION OF DRAWINGS

This present disclosure will be described in detail with reference to embodiments thereof as illustrated in the accompanying drawings and figures, in which like reference numerals are used to indicate identical or functionally similar elements. References to “one embodiment”, “an embodiment”, “an example embodiment”, etc., indicate that the embodiment described may include a particular feature, structure, or characteristic, that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present invention. Other suitable modifications and adaptations of the variety of conditions and parameters normally encountered in the field, and which would be apparent to those skilled in the art, are within the spirit and scope of the invention.

It will be understood that like or analogous elements and/or components, referred to herein, may be identified throughout the drawings with like reference characters.

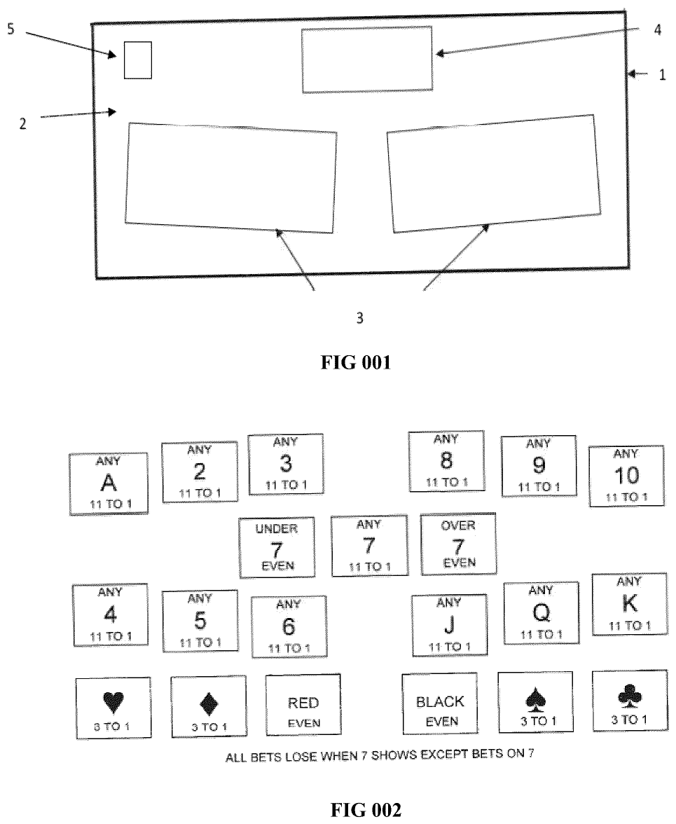

A gaming table is shown in FIG. 001, consisting of a rectangular table 1 having a dealer side and a player side and a playing surface 2. The playing surface 2 having a plurality of betting areas 3, a chip tray 4, a card distribution mechanism 5, and a plurality of cards 6. The plurality of betting areas display payout amounts based on individual attributes of the cards. The plurality of cards 6 may be comprised of one or more standard decks of playing cards, modified standard decks of playing cards comprising more or less than fifty-two cards (e.g., the modified decks may include only the 9, 10, J, Q and K cards of one or more suits or double the amount of face cards), or a special deck comprising a set of cards other than the traditional fifty-two cards of a conventional deck (e.g., tarot cards).

The method of playing a wagering game comprising steps of placing a wager on a plurality of card attributes of an unknown card, displaying one card face up, taking all losing wagers, and paying all winning wagers pursuant to odds displayed in the betting area.

In the preferred embodiment, a gaming table 1 comprised of a playing surface 2 measuring eight-eight inches long and forty inches wide displays two betting areas 3 each measuring thirty-four inches long and sixteen inches wide, wherein each betting area displays betting options of each card denomination with odds of eleven to one, each suit with odds of three to one, under seven and over seven with even odds or a payout equal to the original wager, red and black with even odds as seen in FIG. 002.

Although reference is made herein to what may be done with respect to a particular type of deck, all or many of such embodiments and description may be applied equally to other types of decks and the terms standard, modified standard, and special deck are utilized for illustrative, and non-limiting, purposes only.

The use of blackjack or other types of games is for illustrative purposes only. Some of the embodiments refer to a specific game as the type of game being played, the embodiments described are not limited to application within a specific game and may be included in any game. Similarly, the embodiments described herein are not limited to card games (e.g., the embodiments may be applied in a dice game such as craps).

In traditional blackjack, a player determines a wager for a hand and places the wager. The player is initially dealt two cards from a plurality of standard decks. The player must then make a decision regarding these initial cards (a game play decision, which may include options such as whether to ask for an additional card (“hit”), stay with just the two initial cards (“stand”), split the two cards into two separate hands (“split”), or double an initial wager (“double down”)). A final hand is then determined. Concurrently, a two or more cards are dealt from the deck or set of combined decks to the dealer's initial hand and final hand (based on game play decisions of the dealer or automated game play decisions made by a processor on behalf of the dealer). The game event is then resolved by comparing the final hand of the player to the final hand of the dealer. The winning hand is the one that is closest to the value of twenty-one without going over twenty-one. If the player's final hand wins, an appropriate payout is provided to the player.

In some embodiments, an additional game feature may be played at any point during a game of blackjack whereby the player will provide a wager on a plurality of card attributes of an unknown card to enhance the amount of payout in the event of a winning hand. A player may similarly increase their chances of increasing the payout in poker, craps, or roulette by implementation of the same system and method described herein.

In some embodiments comprising a physical table and physical card distribution mechanism 5 for dispensing cards to a player, in which embodiments a restricted deck does not include certain cards from a standard deck or is limited to include cards of a certain attributes, a software program for directing the physical card distribution mechanism 5 could be programmed to only dispense cards that satisfy a certain condition as an alternative to physically restricting a deck to only include certain cards or to not include certain cards. For example, the card distribution mechanism 5 software may comprise instructions for determining a value of a card that is next up to be dealt and (i) if the value or other characteristic of the card satisfies a condition, outputting or dealing the card; but (ii) if the value or other characteristic of the card does not satisfy the condition, discarding the card or otherwise preventing it from being dealt to a player or dealer. Identifying the card attributes can be done in many different ways known in the art such as an optical recognition reader, RFID tags, bar code, or other similar identifiers.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer readable storage medium such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions with each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Various platforms are contemplated that are suitable for implementation of embodiments of wagering games according to this disclosure. For example, embodiments of wagering games may be implemented as live table games with an in-person dealer, electronic gaming devices, partially or fully automated table games, and fully automated, network-administered games that either produce game results utilizing a processor or produce a live video feed of a dealer administering a game from a remote studio, or other communication network.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device.

In another embodiment, a gaming device such as a traditional gaming cabinet, phone, tablet, or computer, comprised of a player input area configured to enable a player to interact with the gaming device through an input devices such as buttons or a touchscreen, a gaming screen to display graphics for interacting with the gaming device through processing one or more programs stored in memory to implement the rules of game play without involving physical playing cards, chips, other wagering elements, or live personnel. The gaming device may be configured to execute software programs containing computing instructions and may include a plurality of processors, a plurality of memory comprised of Synchronous Random Access Memory (SRAM), Dynamic RAM (DRAM), Read-Only Memory (ROM), Flash memory, disk drives, magnetic tape, CDs (compact discs), DVDs (digital versatile discs or digital video discs), and semiconductor devices such as RAM, DRAM, ROM, EPROM, Flash memory, or other equivalent storage devices, a plurality of displays comprised of light emitting diode displays, liquid crystal displays, cathode ray tubes, user interface elements comprised of keyboards, push buttons, mice, joysticks, haptic devices, microphones, speakers, cameras, and touchscreens, communication elements, or storage devices. A communication device comprised of wired and wireless communication media serial ports, parallel ports, Ethernet connections, universal serial bus connections, 802.11 type wireless networks, cellular telephone/data networks, and other suitable communication interfaces and protocols may be operably coupled to the processor to coordinate information between a plurality of gaming devices and other devices such as a server through a suitable communication medium, such as for example wired networks, Wi-Fi networks, and cellular communication networks employing a client-server architecture.

A person of ordinary skill in the art will recognize that the computing system may be configured in many different ways with different types of interconnecting buses between the various elements. Moreover, the various elements may be subdivided physically, functionally, or a combination thereof. As one non-limiting example, the memory may be divided into cache memory, graphics memory, and main memory. Each of these memories may communicate directly or indirectly with the one or more processors on separate buses, partially-combined buses, or a common bus.

What is claimed is:

1. A gaming system comprising:
at least one physical table;
at least one card distribution mechanism;
at least one physical deck of cards having different attributes;
at least one play of a game including:
(a) receiving a wager from a player relating to at least one attribute of a randomly selected hidden card;
(b) revealing the hidden card;
(c) comparing the player's wager of at least one attribute of the randomly selected hidden card with the hidden card's attributes;
(d) calculating the results of the wager;
(e) paying the winner if the player's wager matched at least one attribute of the randomly selected hidden card;
(f) in successive hands, repeating steps (a) through (f).

2. A method of using a gaming system comprising:
at least one input device;
at least one display device;
at least one processor in communication with said at least one input device and said at least one display device;
at least one memory device storing a plurality of instructions which, when executed by said at least one processor, cause the at least one processor to operate with said at least one input device and said at least one display device for a play of a game including:
(a) receiving a wager from a player relating to at least one attribute of a randomly selected hidden card;
(b) revealing the hidden card;
(c) comparing the player's wager of at least one attribute of the randomly selected hidden card with the hidden card's attributes;
(d) calculating the results of the wager;
(e) paying the winner if the player's wager matched at least one attribute of the randomly selected hidden card;
(f) in successive hands, repeating steps (a) through (f).
